(19) United States
(12) Patent Application Publication
(10) Pub. No.: US 2019/0005594 A1
(43) Pub. Date: Jan. 3, 2019

(54) SYSTEM AND METHOD FOR MATCHING A TENANT OFFICE SPACE PLAN WITH AVAILABLE COMMERCIAL LEASING SPACE

(71) Applicant: POWELL H. MCGILL, FAIRFAX, VA (US)

(72) Inventor: POWELL H. MCGILL, FAIRFAX, VA (US)

(21) Appl. No.: 15/640,445

(22) Filed: Jun. 30, 2017

(51) Int. Cl. G06Q 50/16; G06Q 10/06; G06Q 30/06

(52) U.S. Cl. CPC G06Q 50/163; G06Q 30/0645; G06Q 10/06315

(57) ABSTRACT

This invention relates to commercial real estate office buildings and, more particularly, to a system and method for matching tenant requirements with a landlord broker proposal and outputting a location-modified Client Space Plan.

### CROSS REFERENCE TO RELATED APPLICATIONS

Not applicable.

### STATEMENT REGARDING FEDERALLY SPONSORED RESEARCH OR DEVELOPMENT

No federal government funds were used in researching or developing this invention.

### NAMES OF PARTIES TO A JOINT RESEARCH AGREEMENT

None.

### REFERENCE TO A SEQUENCE LISTING

A table or a computer list appendix on a compact disc

[ ] is
[ ] is not
included herein and the material on the disc, if any, is incorporated-by-reference herein.

### BACKGROUND

### Field of the Invention

This invention relates to commercial real estate office buildings and, more particularly, to a system and method for matching tenant requirements with a landlord broker proposal and outputting a location-modified Tenant-Landlord Space Plan.

### Background of the Invention

A typical process for a tenant looking for new commercial office space is oftentimes a real estate exercise. FIG. 1—Prior Art illustrates a typical process. Determine space requirements, check out locations, review amenities, services, restaurants, a tenant might even review their staffing needs. Then, tenants will typically visit various available commercial spaces, and then make an educated guess as to the commercial spaces which a might be a good fit for the tenant. Although each tenant will necessarily have their own space requirements, the process of using the landlord's architect and engineers to develop a space plan, often benefits the landlord, and does not provide tenant's with space that fits their needs. A common commercial real estate process includes these steps, in order: (1) Determine Space Requirements/Analyze Needs—a. Location, b. Amenity and Service Requirements, c. Space Components/Staffing Projections. (2) Survey Market. (3) Find a selection of Qualified Properties by looking at Location, Amenities and Services, History of Current Landlord. (4) Conduct a Technical Property Review/Physical Tour. (5) Then comes the Proposal Process where a. Prepare the Request for Proposal (RFP), b. Distribute the RFP to Qualified Candidate Buildings, c. Review Proposals (landlord responses), d. Evaluate Offers and prepare the Comparative Lease Analysis; e. Background Report on Owner Performance, Functional Histories, Tenant Satisfaction; and f. Technical and Locational Data is Reviewed. (6) Then Negotiations are started. a. Develop the Negotiation Checklist, b. Solicit Input from Legal Counsel, c. Implementation of Tenant Resources, and d. Mutual Execution of Lease Document. Now that the deal is signed, typically the Planning/Permitting/Construction begins. However, this process, when viewed from the standpoint of the tenant, is often the exact opposite of how a process would develop a suitable space that has the tenat's interest in mind. Accordingly, improvement is needed in how space plans are developed, and how they can be used to aid in the initial search process.

### BRIEF SUMMARY OF THE INVENTION

To provide solutions and/or address shortcoming in the prior art, what if the office space process was not performed as a real estate exercise, but instead, was performed as a design exercise?

Accordingly, the invention provides a method for matching tenant requirements with a landlord broker proposal and outputting a modified Tenant Space Plan for a commercial real estate office building rental space. In a preferred embodiment, the method comprises the steps as follows in sequence.

STEP 1. Receiving a set of ordinal tenant office space variables comprised of tenant building space requirements and generating a Tenant Space Plan comprised of a single integer value for each ordinal tenant office space variable, an engineering drawing, and an architectural drawing.

STEP 2. Uploading the set of ordinal tenant office space variables to an online database containing a plurality of sets of ordinal landlord broker office space variables, each type of variable in the set of ordinal tenant office space variables having a matching type of variable in each of the sets of ordinal landlord broker office space variables, each set of landlord broker office space variables also including a binary availability variable indicating available or not available, a date-available variable, and a first landlord broker-sum variable comprising a sum of the ordinal landlord broker office space variables, each type of variable in the set of ordinal tenant office space variables is associated with a tenant office space variable-specific tenant-side cost figure variable, and each matching type of variable in each of the sets of ordinal landlord broker office space variables is associated with a landlord broker office space variable-specific landlord broker-side cost figure variable.

STEP 3. Calculating a first tenant-sum variable of the set of ordinal tenant office space variables, comparing the first tenant-sum variable to the first landlord broker-sum variables from the sets of ordinal landlord broker office space variables, and generating a first sum-identity list of sets of ordinal landlord broker office space variables where the tenant-sum variable is identical to the landlord broker-sum variables or within 40% of difference between each landlord broker-sum variable and each tenant-sum variable.

STEP 4. Performing a first least squares regression to identify from 3-10 best fit sets from the first sum-identity list of sets and saving to memory.

STEP 5. Identifying a tenant office space variable having the largest variance from the first least squares regression, and generating a second set of ordinal tenant office space variables by removing from the set the tenant office space variable having the largest variance from the first least squares regression, and generating a second sum-identity list of sets of ordinal landlord broker office space variables by removing the matching variable from the first sum-identity sets of landlord broker office space variables.

STEP 6. Performing a second least squares regression to identify from 3-10 second best fit sets from the second sum-identity list of sets and saving to memory.

STEP 7. Outputting a combined list of the 3-10 best fit sets from the first sum-identity list of sets and the 3-10 second best fit sets from the second sum-identity list of sets to a graphical user interface.

STEP 8. Outputting a tenant-side total cost figure from a sum of the tenant office space variable-specific tenant-side cost figure variables, and outputting a landlord broker-side total cost figure next to each of the 3-10 best fit sets from the first sum-identity list of sets where the landlord broker-side total cost figure is a sum of the landlord broker office space variable-specific landlord broker-side cost figure variables from each of the 3-10 best fit sets, and outputting a variance-modified landlord broker-side total cost figure next to each of the 3-10 second best fit sets from the second sum-identity list of sets where the variance-modified landlord broker-side total cost figure is a sum of the landlord broker office space variable-specific landlord broker-side cost figure variables from each of the 3-10 second best fit sets with a premium or discount figure displayed adjacent to the variance-modified landlord broker-side total cost figure.

STEP 9. Receiving a tenant selection input selecting one of the sets from the combined list of the 3-10 best fit sets from the first sum-identity list of sets and the 3-10 second best fit sets from the second sum-identity list of sets.

STEP 10. Generating a modified set of ordinal Tenant Office Space variables by obtaining a mean value of each variable from a sum of each variable of the ordinal Tenant Office Space variables and each variable of the selected set from the combined list of 3-10 best fit sets and the 3-10 second best fit sets. And,

STEP 11. Generating a modified Tenant Space Plan and outputting the modified Tenant Space Plan as a proposal sent electronically to a landlord broker affiliated with the selected set from the combined list of 3-10 best fit sets and the 3-10 second best fit sets.

In preferred embodiments, the requirements comprise: (i) total linear space in square feet, (ii) total number of types of spaces selected from executive office, non-executive window office, non-executive inner office, cubicle work area, reception area, waiting area, conference room, kitchen, break room, lounge area, storage room, internet utility closet, electrical utility closet, washroom, equipment room, print and fax room, elevator area, stairwell area, and temporary office, (iii) sum of a total number of each type of space multiplied by a minimum size of each type, (iv) total space occupied by support columns, (v) total number of walls, (vi) types of walls, (vii) total number of windows, (viii) types of windows, (ix) HVAC capacity and equipment requirements, (x) internet capacity, wired, (xi) internet wireless connectivity, including WiFi beacons, signal boosters, and satellite connectivity, (xii) landscaping, (xiii) interior design plans, (xiv) interior design fixtures and furniture, (xv) floor covering, (xvi) sound-proofing, (xvii) light fixtures, (xviii) ceiling treatments, (xix) bathroom fixtures, furniture and lighting, (xx) maintenance and service options, (xxi) safety features, and (xxii) security features.

In another preferred embodiment is provided the method, comprising additional steps of (i) receiving a signal from the landlord broker for agreement to Tenant Proposal Cost, (ii) auto-generating and outputting a detailed Space Plan including an auto-generated Dynamically Modifiable Global Architectural Plan, and an auto-generated Dynamically Modifiable Global Engineering Plan.

In another preferred embodiment, there is provided a method for generating a modified Tenant Office Space Plan for a commercial real estate office building rental space, comprising the steps: (i) Generating a Tenant Office Space Plan (TOS) and Cost Proposal comprised of a set of pre-defined lease variables; (ii) Sending the TOS to a Landlord Broker Database where multiple Landlord Brokers receive the TOS, each generate a Landlord BOS (LBOS) Counter Proposal, said LBOS comprised of a set of pre-defined lease variables; (iii) sending the multiple LBOSs to a Tenant Broker Proposal (TBP) Database; (iv) Scoring the TOS variable set and multiple LBOS sets and Performing a Least Squares Regression (LSR) to identify best fit sets from the multiple LBOS sets; (v) Identifying TOS variable having largest variance in LSR, discarding the variable and Performing a second LSR to identify second best fit set from second list of LBOS sets; (vi) Outputting the best-fit LBOS and the second best-fit LBOS to a graphical user interface display; (vii) Outputting to the display a variable by variable comparison of TOS, best fit LBOS, and second best fit LBOS; (viii) Receiving Tenant Selection of a LBOS set, and generating a modified Tenant Office Space Plan by averaging Tenant variable values and Landlord variable values on a variable by variable basis, and sending revised proposal to the Landlord Broker for the selected LBOS set.

In another preferred embodiment, there is provided the method herein further comprising the step of (ix) Generating a Matched Tenant-Landlord Space Plan and Cost Proposal and an Auto-generated Architectural and Engineering Plan.

In another preferred embodiment is provided a machine-readable non-transitory medium on which has been prerecorded a computer program which, when executed by a processor, performs the steps of the invention.

In another preferred embodiment, there is provided a system comprised computer-implemented means for performing the steps of the methods described and claimed herein.

### BRIEF DESCRIPTION OF THE DRAWINGS

FIG. 1 is prior art and shows a flow diagram of how tenant-landlord lease transactions typically work in the prior art.

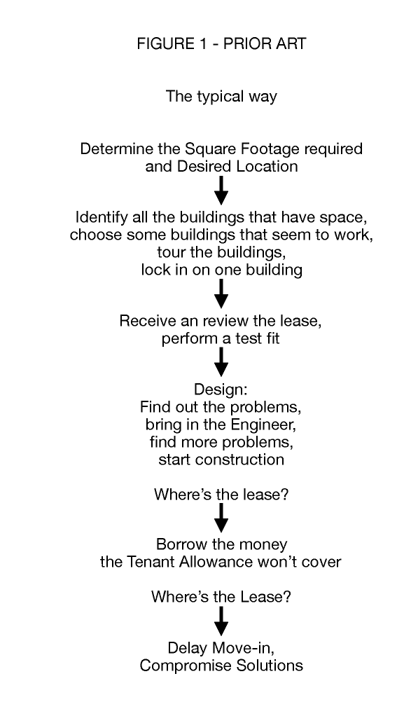

FIG. 2 is a flowchart showing one preferred embodiment of the present invention showing an output of a best match after a first comparison, followed by a dropped outlier/variable, a second iteration, and a successful match output.

FIG. 3 is a flowchart showing another preferred embodiment of the present invention showing an output of a best match after a first comparison, followed by a dropped outlier/variable, a second iteration, a successful match output, and auto-generated dynamic architectural and engineering plans.

FIG. 4 is an illustration showing how lease terms can be quantified and negotiated using the invention provided herein.

FIG. 5 is an illustration of a flow diagram showing the step of converting a Tenant Proposal Cost report into an agreement with a landlord broker that auto-generates an architectural plan and an engineering plan.

FIG. 6 is a block diagram showing how the Landlord broker Office Space (BOS) information is input into a central database, and how a Tenant Office Space (TOS) proposal gets matched after filtering and generates a lease agreement with agreed-upon auto-generated architectural and engineering plans.

FIG. 7 is a flow diagram that shows a process whereby a Tenant Office Space Proposal is submitted to a Landlord Broker Database, and the Landlord Brokers submit a counter-proposal, following which the Landlord Proposals are subjected to a dual LSR analysis to identify a best fit and a second best fit Landlord Proposal, which is transmitted to a Tenant Broker Database, where an variable by variable graphic comparison is generated, and upon receiving a selection signal from the Tenant Broker, a combined average Proposal is sent to the selected Landlord Broker for approval, and architectural and engineering plans are auto-generated from the agreed-upon variables values.

### DETAILED DESCRIPTION OF THE INVENTION

The present invention will now be described more fully with reference to the accompanying drawings, in which several embodiments of the invention are shown. This invention may, however, be embodied in various forms and should not be construed as being limited to the embodiments set forth herein. Rather, these embodiments are provided so that this disclosure will be thorough and complete, and will fully convey the scope of the invention to those skilled in the art.

It will be appreciated that the present disclosure may be embodied as methods, systems, or computer program products. Accordingly, the present inventive concepts disclosed herein may take the form of a hardware embodiment, a software embodiment or an embodiment combining software and hardware aspects. Furthermore, the present inventive concepts disclosed herein may take the form of a computer program product on a computer readable storage medium having non-transitory computer usable program code embodied in the medium. Any suitable computer readable medium may be utilized including hard disks, CD-ROMs, optical storage devices, flash memories, or magnetic storage devices.

Computer program code or software programs that are operated upon or for carrying out operations according to the teachings of the invention may be written in a high level programming language such as C, C++, JAVA®, Smalltalk, JavaScript®, Visual Basic®, TSQL, Python, Ruby, Perl, use of .NETTM Framework, Visual Studio® or in various other programming languages. Software programs may also be written directly in a native assembler language for a target processor. A native assembler program uses instruction mnemonic representations of machine level binary instructions. Program code or computer readable medium as used herein refers to code whose format is understandable by a processor. Software embodiments of the disclosure do not depend upon their implementation with a particular programming language.

As provided herein, finding and negotiating office space is a design exercise, not a real estate exercise. The goal is to design a prototype transaction before the market is engaged. (1) Design and price the most desirable space plan, and (2) design the lease language that best serves your business. In one aspect, the invention conceptually discloses the following steps.

1. Prototype Transaction

1.1 Using an architect/space planner, create “best of all worlds” space plan, including space program, adjacency plan, block plan.

1.2. Using an MEP engineer, create an executive summary detailing the cost and construction schedule of proposed tenant improvements.

1.3. Using an expert in commercial lease language, create a document that describes the desired business concepts correlating to specific provisions expected in an acceptable lease document.

2. RFP & Negotiations

2.1 Create an RFP that asks for specific base building information including power, HVAC and all mechanics, roof, maintenance history, operating expenses.

2.2 Addend prototype materials as exhibits.

2.3 Buildings who respond inadequately or incompletely will be eliminated from the competition.

2.4 Minor deal points will be negotiated by redline iterations of the RFP, with the final version serving as an LOI.

3. Survey Market

4. Create a Market

4.1 Define a deal market; not a geographical one.

4.2 Identify no more than 10 buildings that appear to accommodate prototype criteria.

4.3 Distribute RFPs to building representatives.

4.4 Inform buildings that in order to compete for the transaction, the RFP must be precisely responded to.

4.5 The market is defined by the respondents.

5. Tour the Market

5.1 Buildings that respond positively to the RFP will be physically toured and inspected.

5.2 Market may be further defined by factors pertaining to location, ingress/egress, curb appeal, view, etc.

5.3 Ideally, the final competition will consist of 3-5 buildings.

5.4 Receive & review lease documents from finalists.

6. Construction and move-in.

The reason most companies don't perform the Prototype Transaction of Step #1 is that they don't understand the importance of it, and even if they do they don't want to pay for it upfront. Especially small to medium sized companies. That is why this is a critical nature of a prototype transaction, and provides benefits to the tenant by paying for the exercise.

The overall objective of the inventive methods and systems is to transfer leverage from the landlord to the tenant. The operative word is control. The further a tenant moves into a negotiation the less control he has. So it's important to anchor the negotiation at the very beginning.

As defined herein the collection of data in the database is managed by a database management system to allow the definition, creation, querying, updating, and administration of the database. Well known systems that support relational and post-relational models include MySQL, PostgreSQL, MS-SQL Server, Oracle, Sybase, IBM DB2, and XML db systems such as NoSQL, NewSQL.

Existing DBMSs provide various functions for managing a database and its data which can be classified into four main functions:

Data definition—Creation, modification and removal of definitions that define the organization of the data.

Update—Insertion, modification, and deletion of the actual data.

Retrieval—Providing information in a form directly usable or for further processing by other applications. The retrieved data may be made available in a form basically the same as it is stored in the database or in a new form obtained by altering or combining existing data from the database.

Administration—Registering and monitoring users, enforcing data security, monitoring performance, maintaining data integrity, dealing with concurrency control, and recovering information that has been corrupted by some event such as an unexpected system failure.

Application Programming Interfaces (APIs)

In a preferred aspect, the invention uses an application programming interface (API) architecture to define the programmable interfaces through which the system interacts with applications that use its assets. This allows the programmable interfaces to provide different sets of services to different application serving different types of consumers. The API disclosed herein uses custom library code in order to provide reuseable modules that are determined based upon the user interface that is accessing the library. These precoded modules allow application-specific access to the database that contains the real-time data feeds from multiple external systems that have been converted into the device-modified special purpose output data feed for distribution to displays and user equipment.

In a preferred aspect, the API architecture includes an end user component that interacts with a client applications component where the client applications component connects to and leverages a core API infrastructure. In one preferred embodiment of the invention, the core API infrastructure includes a security layer that interfaces with a caching layer, a representation layer connected to the caching layer, an orchestration layer between the representation layer and the API implementation layer, and a backend layer interfacing with the API implementation layer.

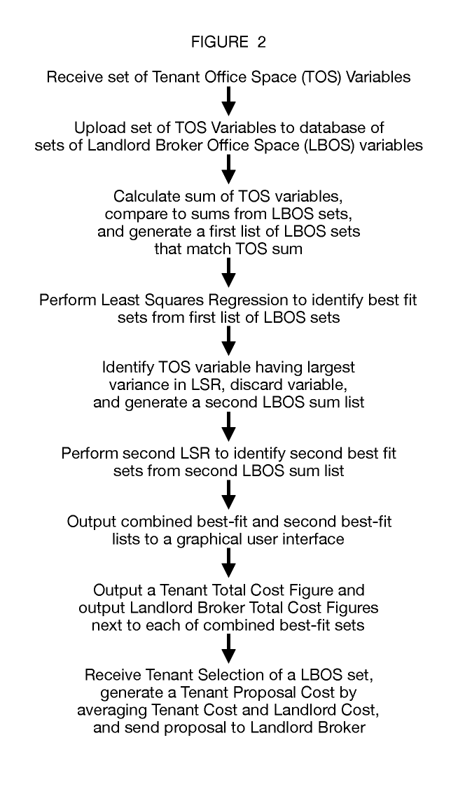

Referring now to the Figures, FIG. 2 is a flowchart showing one preferred embodiment of the present invention. In step 1, a client's desired set of requirements is set forth from a closed set of variables representing features of a lease transaction. This set of Tenant Office Space variables is input into the invention. In a preferred embodiment, the TOS variables are entered into a secure, closed, cloud-based system having a pre-populated database of broker provided information. In a preferred embodiment, the landlord brokers are system subscribers and their variables allow for dynamic searching by subscriber tenants. In Step 2, this Tenant Set is compared against a finite universe of Sets of Landlord broker Office Space variables. In a preferred embodiment, the chances of matching a tenant to a landlord broker is increased by identifying an outlier variable, and re-calculating and re-outputting the best-fit landlord broker sets. In Step 3, after the initial filter is performed, the second filter is applied by summing Tenant variables into a single integer and comparing against the sums from each of the Landlord broker Sets. In Step 4, once the universe of Landlord broker Sets is reduced to identical or closely value sets, a Least Squares regression is performed to find a best fit of Landlord broker Sets that match the Tenant Model requirements. These best-fit matches are outputted to a Tenant display and then the Tenant inputs a selection of a landlord broker, and a combined, averaged Tenant Proposal Cost is generated by averaging the tenant and the landlord broker cost inputs. This Tenant Proposal Cost can be weighted according to user preference, or can be a straight average sum divided by two. The Tenant Proposal Cost is then transmitted to the landlord broker.

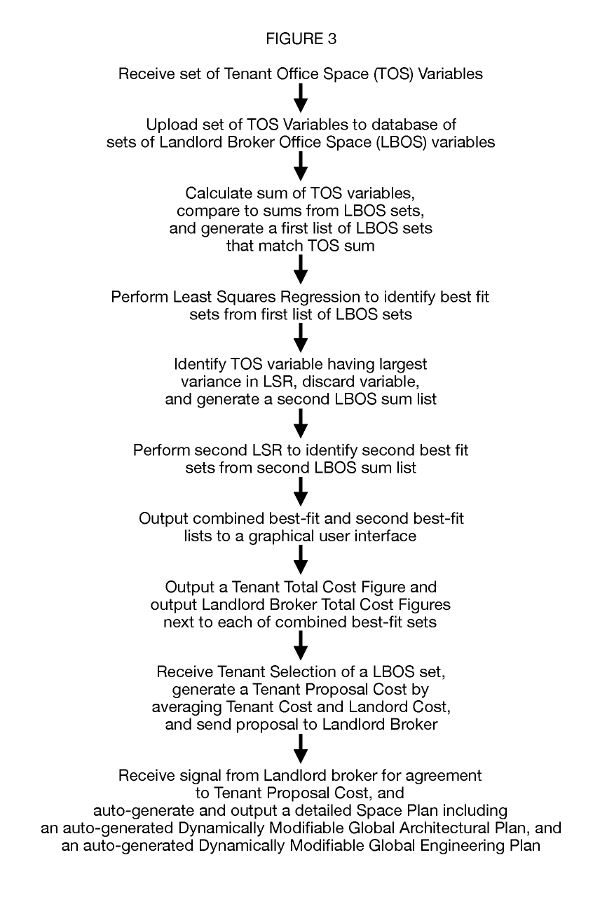

FIG. 3 is a flowchart showing another preferred embodiment of the present invention. In FIG. 3, Step 1 provides (i) Receiving a set of Tenant Office Space (TOS) Variables. Step 2 provides (ii) Uploading the set of TOS Variables to a database of sets of Landlord broker Office Space (BOS) variables. Step 3 provides (iii) Calculating a sum of TOS variables, comparing to sums from BOS sets, and generating a first list of BOS sets that match TOS sum as a first pass filter. Step 4 provides (iv) Performing a Least Squares Regression to identify best fit sets from first list of BOS sets. Step 5 provides (v) Identifying a TOS variable having largest variance in LSR, discarding that large variance variable, and re-generating a (second) BOS sum list. Step 6 provides (vi) Performing a second LSR to identify second best fit sets from second BOS sum list. Step 7 provides (vii) Outputting combined best-fit and second best-fit lists to a graphical user interface. Step 8 provides (viii) Outputting a Tenant Total Cost Figure and outputting Landlord broker Total Cost Figures next to each of combined best-fit sets. Step 9 provides (ix) Receiving from the Tenant, their Selection of a BOS set, and generating a Tenant Proposal Cost. In one embodiment, the Tenant Proposal Cost may be generated by averaging Tenant Cost and Landlord broker Cost. In other embodiments, the value is weighted. The TPC is then sent proposal to the matched Landlord broker. Step 10 may include (x) Receiving a signal from the matched landlord broker indicating that the landlord broker has accepted the tenant proposal cost agreement. Next, Step 11 may include (xi) auto-generating and outputting a detailed Space Plan including an auto-generated Dynamically Modifiable Global Architectural Plan, and an auto-generated Dynamically Modifiable Global Engineering Plan.

Dynamically modifiable global plans are dynamic in that the variables can be changed by the Tenant and/or Landlord broker, and the architectural plan and the engineering plan, which were auto-generated using the original variable values, are now modified and updated.

Architectural drawings provide a preliminary layout specifying walls, doors, windows, and elevation views of specific areas such as the main lobby, conference rooms, hallways, typical executive offices, and so forth. The exact dimensions of the size and shape of the floor or floors is input by a landlord broker-subscriber who is a subscriber-member of the system of the present invention. Changes to the size of rooms, width of hallways, size of lobby, etc. by either a Tenant-subscriber or landlord broker-subscriber will dynamically modify the architectural drawings. By keeping track of total floor sizes and size of obstructions such as columns, the vector graphics will refresh to a different size based on selections made by the users.

Once architectural drawings are available, auto-generation of engineering drawings is provided. Engineering drawings usually include the location and type of electrical services and heating, ventilating, and air conditioning, all of which are subject to codes and regulations. Additionally, engineering drawings will include detailed mechanical and electrical drawings for specifications for supports, stud spacing and the position, number and capacity of electrical services, minimum wall insulation rating which sets minimum wall thickness, the form of electrical services which determines the size and locations of the motor control centers, and so forth.

Office Space Variables

Variables included within the scope of the invention include the following non-limiting list.

Cost per rentable square foot: U_{SD}

Annual escalation: U_{PLUS}

Rentable Square Feet: S_{T}

Usable Square Feet: S_{U}

Real estate taxes: T_{AX}

Number of Floors: F

Length of lease term: M_{OS}

Tenant construction approval: TEN_{CNTL}

Number of executive offices: O_{E}

Number of non-executive window offices: O_{W}

Number of non-executive inner offices: O_{I}

Cubicle office space: O_{C}

Reception area: R

Lobby finishes: R_{FIX}

Waiting area: W

Conference rooms: C

Kitchen: K

Break room: B

Lounge area: L

Storage area: S_{O}

Internet utility closet: U_{I}

Electrical utility closet: U_{E}

Telephone closet/panel: B_{ELL}

Washroom: T

Equipment room: E_{Q}

Print and fax room: P

Elevator area: E_{L}

Elevator finishes: E_{FIX}

Freight elevator: E_{FR}

Stairwell area: S_{T}

Temporary office: O_{T}

Sum of a total number of each type of space

multiplied by a minimum size of each type: SUM_{TYPE}

Total space occupied by support columns: C_{OL}

Total number of walls: W_{AL}

Types of walls: W_{ALT}

Total number of windows: W_{IN}

Types of windows: W_{INT}

Window treatments: B_{LIND}

HVAC capacity and equipment requirements: H_{VAC}

HVAC number of vents and intakes: H_{VACT}

Internet capacity, ethernet wired: E_{MBPS}

Internet wireless capacity: W_{MBPS}

WiFi beacons, signal boosters, and satellite connectivity: WIFI_{ALT}

Power generator: P_{WR}

Power per Square Foot Available: W_{ATTSF}

Water, sewer supply available: H_{2O}

Environmental Certificates, ratings: L_{EED}

Landscaping: L_{AND}

Interior design plans: INT_{PLAN}

Interior design fixtures and furniture: INT_{FIX}

Floor covering: F_{LOR}

Sound-proofing: DB_{LESS}

Light fixtures: L_{UM}

Ceiling treatments: C_{EIL}

Bathroom fixtures: WC_{FIX}

Furniture and lighting: F_{URN}

Maintenance and service options: M_{AINT}

Safety features, strobes, sprinklers, extinsguishers: F_{IRE}

Safety features, medical, AED devices: M_{ED}

Security features, coded entry, cameras: M_{IL}

Parking: L_{OT}

Tenant Signage: S_{IGN}

Insurance: I_{NS}

Sublease: S_{UB}

Security deposit: D_{EP}

Hazardous materials, conditions compliance: H_{AZ}

Disability compliance: A_{DA}

Termination of lease: E_{ND}

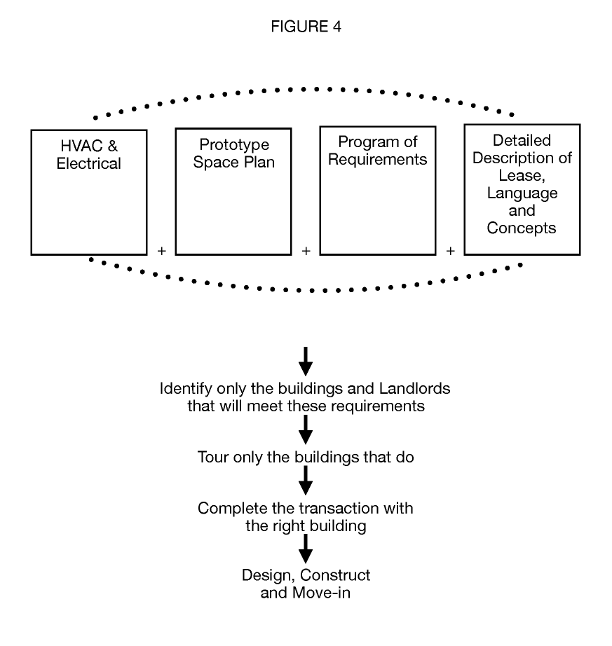

FIG. 4 is an illustration showing how lease terms can be quantified and negotiated using the invention provided herein. HVAC & Electrical Engineering Standards are well known and adaptable for providing a menu of options to users, followed with the automated generation of standardized CAD drawings once the selection is made. This provides the opportunity for a Prototype Space Plan, which can dovetail with a program of requirements, and a detailed description of lease, language and concepts. The result is that the process will identify participating buildings and landlords that meet a tenant's requirements. The Tenant will then only need to physically visit buildings that have been so qualified. Eventually, the Tenant will be able to avoid the waste of time that comes from going down false paths, and the Tenant will be able to complete transactions with the right building on the right terms.

### Example

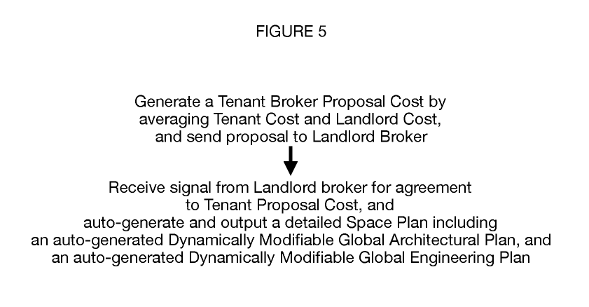

Referring now to FIG. 5, an example is provided of the step of converting a Tenant Proposal Cost report into an agreement with a landlord broker that auto-generates an architectural plan and an engineering plan. In this example, a Tenant securely logs in to a secure system, and enters the following variables.

Cost per rentable square foot: U_{SD}=42

Annual escalation: U_{PLUS}=0.05

Rentable Square Feet: S_{T}=20 k

Usable Square Feet: S_{U}=18 k

Real estate taxes: T_{AX}=6 k

Number of Floors: F=2

Length of lease term: M_{OS}=60

Tenant construction approval: TEN_{CNTL}=0

Number of executive offices: O_{E}=8

Number of non-executive window offices: O_{W}=32

Number of non-executive inner offices: O_{I}=12

Cubicle office space: O_{C}=2

Reception area: R=1

Lobby finishes: R_{FIX}=10

Waiting area: W=1

Conference rooms: C=2

Kitchen: K=1

Break room: B=2

Lounge area: L=0

Storage area: S_{O}=2

Internet utility closet: U_{I}=2

Electrical utility closet: U_{E}=1

Telephone closet/panel: B_{ELL}=1

Washroom: T=4

Equipment room: E_{Q}=1

Print and fax room: P=1

Elevator area: E_{L}=2

Elevator finishes: E_{FIX}=5

Freight elevator: E_{FR}=1

Stairwell area: S_{T}=4

Temporary office: O_{T}=2

Sum of a total number of each type of space multiplied by a minimum size of each type: SUM_{TYPE}=14 k

Total space occupied by support columns: C_{OL}=0.5 k

Total number of walls: W_{AL}=10

Types of walls: W_{ALT}=5

Total number of windows: W_{IN}=8

Types of windows: W_{INT}=8

Window treatments: B_{LIND}=4

HVAC capacity and equipment requirements: H_{VAC}=7

HVAC number of vents and intakes: H_{VACT}=5

Internet capacity, ethernet wired: E_{MBPS}=6

Internet wireless capacity: W_{MBPS}=8

WiFi beacons, signal boosters, and satellite connectivity: WIFI_{ALT}=10

Power generator: P_{WR}=2

Power per Square Foot Available: W_{ATTSF}=10

Water, sewer supply available: H_{2O}=1

Environmental Certificates, ratings: L_{EED}=1

Landscaping: L_{AND}=0

Interior design plans: INT_{PLAN}=5

Interior design fixtures and furniture: INT_{FIX}=5

Floor covering: F_{LOR}=0

Sound-proofing: DB_{LESS}=10

Light fixtures: L_{UM}=50

Ceiling treatments: C_{EIL}=2

Bathroom fixtures: WC_{FIX}=10

Furniture and lighting: F_{URN}=10

Maintenance and service options: M_{AINT}=2

Safety features, strobes, sprinklers, extinguishers: F_{IRE}=23

Safety features, medical, AED devices: M_{ED}=2

Security features, coded entry, cameras: M_{IL}=10

Parking: L_{OT}=60

Tenant Signage: S_{IGN}=5

Insurance: I_{NS}=1

Sublease: S_{UB}=0

Security deposit: D_{EP}=0

Hazardous materials, conditions compliance: H_{AZ}=1

Disability compliance: A_{DA}=1

Termination of lease: E_{ND}=0

Depending on weighting of each variable, a Tenant Proposal Cost can be generated based on Tenant needs. Similarly, a Landlord broker Cost can be generated based on a particular property. Depending on the filters use, multiple properties will be found in a filtering search for matches.

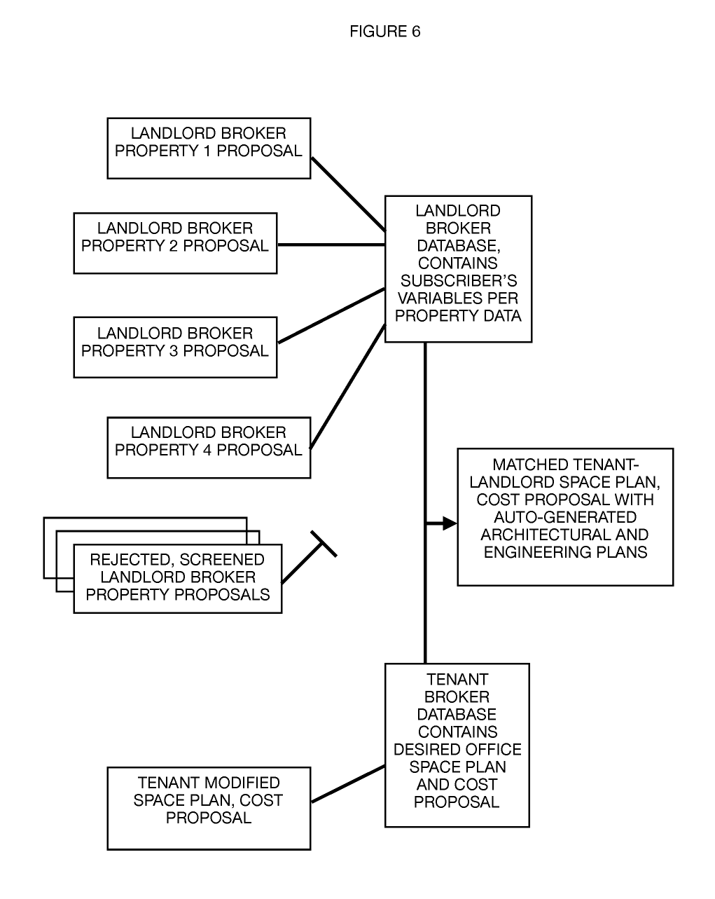

Referring now to FIG. 6, a block diagram shows how the Landlord broker Office Space (LBOS) information is input into a central database, and how a Tenant Office Space (TOS) proposal gets matched after filtering and generates a lease agreement with agreed-upon auto-generated architectural and engineering plans. FIG. 6 also shows the filtering of the Landlord broker database to improve search results and remove rejected, screened, non-qualifying landlord broker property proposals.

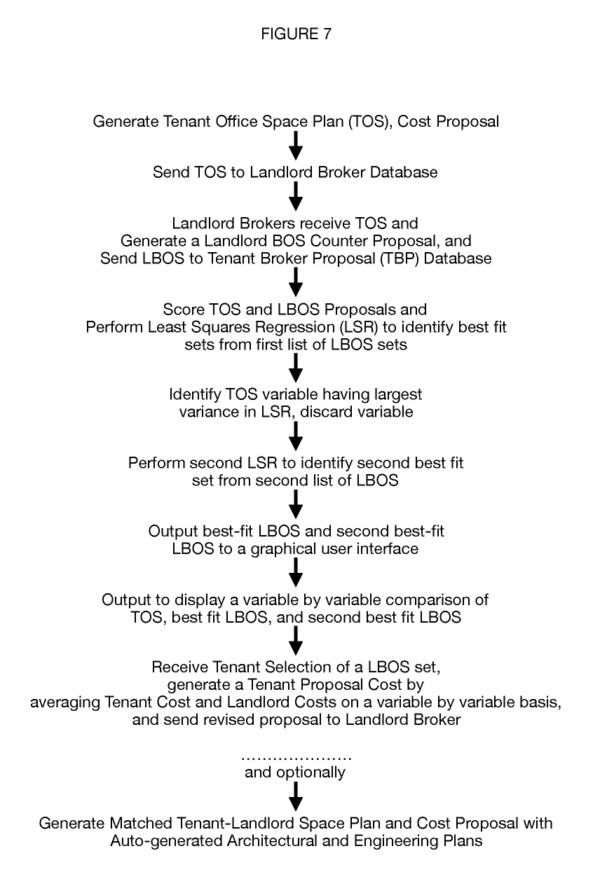

Referring now to FIG. 7, a flow diagram shows a process comprising: (1) Generate Tenant Office Space Plan (TOS), Cost Proposal, (2) Send TOS to Landlord Broker Database, (3) Landlord Brokers receive TOS and Generate a Landlord BOS Counter Proposal, and Send LBOS to Tenant Broker Proposal (TBP) Database, (4) Score TOS and LBOS Proposals and Perform Least Squares Regression (LSR) to identify best fit sets from first list of LBOS sets, (5) Identify TOS variable having largest variance in LSR, discard variable, (6) Perform second LSR to identify second best fit set from second list of LBOS, (7) Output best-fit LBOS and second best-fit LBOS to a graphical user interface, (8) Output to display a variable by variable comparison of TOS, best fit LBOS, and second best fit LBOS, (9) Receive Tenant Selection of a LBOS set, generate a Tenant Proposal Cost by averaging Tenant Cost and Landlord Costs on a variable by variable basis, and send revised proposal to Landlord Broker, and optionally (10) Generate Matched Tenant-Landlord Space Plan and Cost Proposal with Auto-generated Architectural and Engineering Plans.

The references recited herein are incorporated herein in their entirety, particularly as they relate to teaching the level of ordinary skill in this art and for any disclosure necessary for the commoner understanding of the subject matter of the claimed invention. It will be clear to a person of ordinary skill in the art that the above embodiments may be altered or that insubstantial changes may be made without departing from the scope of the invention. Accordingly, the scope of the invention is determined by the scope of the following claims and their equitable Equivalents.

What is claimed is:

1. A method for generating a modified Tenant Space Plan for a commercial real estate office building rental space, comprising the steps:
Receiving a set of ordinal tenant office space variables comprised of tenant building space requirements and generating a Tenant Space Plan comprised of a single integer value for each ordinal tenant office space variable, an engineering drawing, and an architectural drawing;
Uploading the set of ordinal tenant office space variables to an online database containing a plurality of sets of ordinal landlord broker office space variables, each type of variable in the set of ordinal tenant office space variables having a matching type of variable in each of the sets of ordinal landlord broker office space variables, each set of landlord broker office space variables also including a binary availability variable indicating available or not available, a date-available variable, and a first landlord broker-sum variable comprising a sum of the ordinal landlord broker office space variables, each type of variable in the set of ordinal tenant office space variables is associated with a tenant office space variable-specific tenant-side cost figure variable, and each matching type of variable in each of the sets of ordinal landlord broker office space variables is associated with a landlord broker office space variable-specific landlord broker-side cost figure variable;
Calculating a first tenant-sum variable of the set of ordinal tenant office space variables, comparing the first tenant-sum variable to the first landlord broker-sum variables from the sets of ordinal landlord broker office space variables, and generating a first sum-identity list of sets of ordinal landlord broker office space variables where the tenant-sum variable is identical to the landlord broker-sum variables or within 40% of difference between each landlord broker-sum variable and each tenant-sum variable;
Performing a first least squares regression to identify from 3-10 best fit sets from the first sum-identity list of sets and saving to memory;
Identifying a tenant office space variable having the largest variance from the first least squares regression, and generating a second set of ordinal tenant office space variables by removing from the set the tenant office space variable having the largest variance from the first least squares regression, and generating a second sum-identity list of sets of ordinal landlord broker office space variables by removing the matching variable from the first sum-identity sets of landlord broker office space variables;
Performing a second least squares regression to identify from 3-10 second best fit sets from the second sum-identity list of sets and saving to memory;
Outputting a combined list of the 3-10 best fit sets from the first sum-identity list of sets and the 3-10 second best fit sets from the second sum-identity list of sets to a graphical user interface;
Outputting a tenant-side total cost figure from a sum of the tenant office space variable-specific tenant-side cost figure variables, and outputting a landlord broker-side total cost figure next to each of the 3-10 best fit sets from the first sum-identity list of sets where the landlord broker-side total cost figure is a sum of the landlord broker office space variable-specific landlord broker-side cost figure variables from each of the 3-10 best fit sets, and outputting a variance-modified landlord broker-side total cost figure next to each of the 3-10 second best fit sets from the second sum-identity list of sets where the variance-modified landlord broker-side total cost figure is a sum of the landlord broker office space variable-specific landlord broker-side cost figure variables from each of the 3-10 second best fit sets with a premium or discount figure displayed adjacent to the variance-modified landlord broker-side total cost figure;
Receiving a tenant selection input selecting one of the sets from the combined list of the 3-10 best fit sets from the first sum-identity list of sets and the 3-10 second best fit sets from the second sum-identity list of sets;
Generating a modified set of ordinal Tenant Office Space variables by obtaining a mean value of each variable from a sum of each variable of the ordinal Tenant Office Space variables and each variable of the selected set from the combined list of 3-10 best fit sets and the 3-10 second best fit sets; and,
Generating a modified Tenant Space Plan and outputting the modified Tenant Space Plan as a proposal sent electronically to a landlord broker affiliated with the selected set from the combined list of 3-10 best fit sets and the 3-10 second best fit sets.

2. The method of claim 1, wherein said requirements are selected from the group consisting of: (i) total linear space in square feet, (ii) total number of types of spaces selected from executive office, non-executive window office, non-executive inner office, cubicle work area, reception area, waiting area, conference room, kitchen, break room, lounge area, storage room, internet utility closet, electrical utility closet, washroom, equipment room, print and fax room, elevator area, stairwell area, and temporary office, (iii) sum of a total number of each type of space multiplied by a minimum size of each type, (iv) total space occupied by support columns, (v) total number of walls, (vi) types of walls, (vii) total number of windows, (viii) types of windows, (ix) HVAC capacity and equipment requirements, (x) internet capacity, wired, (xi) internet wireless connectivity, including WiFi beacons, signal boosters, and satellite connectivity, (xii) landscaping, (xiii) interior design plans, (xiv) interior design fixtures and furniture, (xv) floor covering, (xvi) sound-proofing, (xvii) light fixtures, (xviii) ceiling treatments, (xix) bathroom fixtures, furniture and lighting, (xx) maintenance and service options, (xxi) safety features, and (xxii) security features.

3. The method of claim 2, comprising additional steps of (i) receiving a signal from the landlord broker for agreement to Tenant Proposal Cost, (ii) auto-generating and outputting a detailed Space Plan including an auto-generated Dynamically Modifiable Global Architectural Plan, and an auto-generated Dynamically Modifiable Global Engineering Plan.

4. A method for generating a modified Tenant Office Space Plan for a commercial real estate office building rental space, comprising the steps:
(1) Generating a Tenant Office Space Plan (TOS) and Cost Proposal comprised of a set of pre-defined lease variables;
(2) Sending the TOS to a Landlord Broker Database where multiple Landlord Brokers receive the TOS, each generate a Landlord BOS (LBOS) Counter Proposal, said LBOS comprised of a set of pre-defined lease variables;
(3) sending the multiple LBOSs to a Tenant Broker Proposal (TBP) Database;
(4) Scoring the TOS variable set and multiple LBOS sets and Performing a Least Squares Regression (LSR) to identify best fit sets from the multiple LBOS sets;
(5) Identifying TOS variable having largest variance in LSR, discarding the variable and Performing a second LSR to identify second best fit set from second list of LBOS sets;
(6) Outputting the best-fit LBOS and the second best-fit LBOS to a graphical user interface display;
(7) Outputting to the display a variable by variable comparison of TOS, best fit LBOS, and second best fit LBOS;
(8) Receiving Tenant Selection of a LBOS set, and generating a modified Tenant Office Space Plan by averaging Tenant variable values and Landlord variable values on a variable by variable basis, and sending revised proposal to the Landlord Broker for the selected LBOS set.

5. The method of claim 4, further comprising the step of (9) Generating a Matched Tenant-Landlord Space Plan and Cost Proposal and an Auto-generated Architectural and Engineering Plan.

6. A machine-readable non-transitory medium on which has been prerecorded a computer program which, when executed by a processor, performs the steps of claim 1.

7. A machine-readable non-transitory medium on which has been prerecorded a computer program which, when executed by a processor, performs the steps of claim 4.

8. A system for generating a modified Tenant Space Plan for a commercial real estate office building rental space, comprising computer-implemented means for performing the steps of claim 1.

9. A system for generating a modified Tenant Space Plan for a commercial real estate office building rental space, comprising computer-implemented means for performing the steps of claim 4.
